(19) United States
(12) Patent Application Publication
(10) Pub. No.: US 2025/0142276 A1
(43) Pub. Date: May 1, 2025

(54) METHODS AND DEVICES FOR RENDERING AN AMBISONICS AUDIO SIGNAL

(71) Applicants: Dolby Laboratories Licensing Corporation, San Francisco, CA (US); Dolby International AB, Dublin (IE)

(72) Inventors: Saketh SATHUVALLI, Bangalore (IN); Christof Joseph FERSCH, Neumarkt (DE); Panji SETIAWAN, Munich (DE); Tripti TIWARI, Bengaluru (IN); Reshma RAI, Bangalore (IN)

(73) Assignees: Dolby Laboratories Licensing Corporation, San Francisco, CA (US); Dolby International AB, Dublin (IE)

(21) Appl. No.: 18/835,523

(22) PCT Filed: Feb. 3, 2023
(86) PCT No.: PCT/US2023/061918

§ 371 Date: Aug. 2, 2024

Related U.S. Application Data
(60) Provisional application No. 63/330,687, filed on Apr. 13, 2022.

(30) Foreign Application Priority Data
Feb. 3, 2022 (IN) 202241005922
Apr. 13, 2022 (EP) 22168180.2

(51) Int. Cl. H04S 3/00

(52) U.S. Cl. CPC H04S 3/008; H04S 2420/11

(57) ABSTRACT

The present document describes a method (400) for rendering an ambisonics signal using a loudspeaker arrangement comprising S loudspeakers. The method (400) comprises converting (401) a set of N ambisonics channel signals (111) into a set of unfiltered pre-rendered signals (211), with N>1 and S>1. Furthermore, the method (400) comprises performing (402) near field compensation, referred to as NFC, filtering of M unfiltered pre-rendered signals (211) of the set of unfiltered pre-rendered signals (211) to provide a set of S filtered loudspeaker channel signals (114) for rendering using the corresponding S loudspeakers.

### CROSS-REFERENCE TO RELATED APPLICATION

This application claims priority of the following priority applications: U.S. Patent Application No. 63/330,687 (reference: D21151USP1), filed 13 Apr. 2022, EP Patent Application No. 22168180.2 (reference: D21151EP), filed 13 Apr. 2022, and IN Patent Application No. 202241005922 (reference: D21151IN), filed 3 Feb. 2022.

### TECHNICAL FIELD

The present document relates to the efficient rendering of an ambisonics audio signal.

### BACKGROUND

The sound or soundfield within the listening environment of a listener that is placed at a listening position may be described using an ambisonics (audio) signal. The ambisonics signal may be viewed as a multi-channel audio signal, with each channel corresponding to a particular directivity pattern of the soundfield at the listening position of the listener. An ambisonics signal may be described using a three-dimensional (3D) cartesian coordinate system, with the origin of the coordinate system corresponding to the listening position, the x-axis pointing to the front, the y-axis pointing to the left and the z-axis pointing up.

By increasing the number of audio signals or channels and by increasing the number of corresponding directivity patterns (and corresponding panning functions), the precision with which a soundfield is described may be increased. By way of example, a first order ambisonics signal comprises N=4 channels or waveforms, namely a W channel indicating an omnidirectional component of the soundfield, an X channel describing the soundfield with a dipole directivity pattern corresponding to the x-axis, a Y channel describing the soundfield with a dipole directivity pattern corresponding to the y-axis, and a Z channel describing the soundfield with a dipole directivity pattern corresponding to the z-axis. A second order ambisonics signal comprises N=9 channels including the 4 channels of the first order ambisonics signal (also referred to as the B-format) plus 5 additional channels for different directivity patterns. In general, an n-order ambisonics signal comprises N=(n+1)² channels including the n² channels of the (n−1)-order ambisonics signals plus [(n+1)²−n²] additional channels for additional directivity patterns (when using a 3D ambisonics format). n-order ambisonics signals for n>1 may be referred to as higher order ambisonics (HOA) signals.

An HOA signal may be used to describe a 3D soundfield independently from an arrangement of speakers, which is used for rendering the HOA signal. Example arrangements of speakers comprise headphones or one or more arrangements of loudspeakers or a virtual reality rendering environment. Hence, it may be beneficial to provide an HOA signal to an audio render, in order to allow the audio render to flexibly adapt rendering of the HOA signal to different arrangements of speakers.

### SUMMARY

The present document addresses the technical problem of rendering an ambisonics audio signal in an efficient manner. The technical problem is solved by the independent claims. Preferred examples are described in the dependent claims.

According to a first aspect, a method for rendering an ambisonics signal using a loudspeaker arrangement comprising S loudspeakers is described. The method comprises converting a set of N ambisonics channel signals into a set of unfiltered pre-rendered signals, wherein N>1 and S>1, and wherein N may differ from S. Furthermore, the method comprises performing near field compensation, referred to as NFC, filtering of M unfiltered pre-rendered signals of the set of unfiltered pre-rendered signals to provide a set of S filtered loudspeaker channel signals for rendering using the corresponding S loudspeakers. M may depend on the number of loudspeakers S and an order n of a higher order ambisonics (HOA) signal corresponding to the set of N ambisonics channel signals. More particularly, M=S*(n+1−m₁), and m₁ is a number of ambisonics channel modes out of the order n of the HOA signal filtered by an all-pass NFC filter. If no all-pass NFC filter is used m₁=0. The set of N ambisonics channel signals may be a higher order ambisonics (HOA) signal. Additionally, or alternatively, N=(n+1)², with n being an order of the HOA signal, with n>1. Additionally, S may be larger than 2. In specific examples, S may be equal to 6 or 16.

In some embodiments, performing NFC filtering of M unfiltered pre-rendered signals of the set of unfiltered pre-rendered signals to provide a set of S filtered loudspeaker channel signals for rendering using the corresponding S loudspeakers may include, determining a set of M filtered pre-rendered signals from M unfiltered pre-rendered signals of the set of unfiltered pre-rendered signals based on NFC coefficients. In particular, this determination may include multiplication in the frequency domain of each of the S unfiltered pre-rendered signals of M unfiltered pre-rendered signals of the set of unfiltered pre-rendered signals with an NFC coefficient d(m), for each m, 0≤m≤n. Alternatively, this determination may include convolution in the time domain of each of the S unfiltered pre-rendered signals of M unfiltered pre-rendered signals of the set of unfiltered pre-rendered signals with an NFC filter dₘ, for each m, 0≤m≤n. The method may further include summing the filtered pre-rendered signals and the remaining unfiltered signals, corresponding to a loudspeaker, for each loudspeaker S to provide the set of S filtered loudspeaker channel signals. The number of filtered pre-rendered signals may be n+1−m₁. Note that at the end, the summation shall include the m₁ unfiltered pre-rendered signals corresponding to a loudspeaker. This is because the remaining S*m₁ unfiltered pre-rendered signals still need to be made available and considered (although no actual filtering is applied due to the all-pass property) to properly obtain the final S filtered loudspeaker channel signals.

In some embodiments, the method may further include determining whether (N−m₀) is less than M, wherein m₀≥0 and depends on a number of ambisonics channel modes out of the order n of the HOA signal filtered by an all-pass NFC filter. m₀ may be a number of ambisonics channel indices corresponding to the number of ambisonics channel modes filtered by an all-pass NFC filter. If no all-pass NFC filter is used m₀=0. Further, performing near field compensation, referred to as NFC, filtering of M unfiltered pre-rendered signals of the set of unfiltered pre-rendered signals to provide a set of S filtered loudspeaker channel signals for rendering using the corresponding S loudspeakers may include performing NFC filtering on M unfiltered pre-rendered signals of the set of unfiltered pre-rendered signals if, in particular only if, (N−m₀)>M or (N−m₀)≥M.

In some embodiments, before converting a set of N ambisonics channel signals into a set of unfiltered pre-rendered signals, the method may further include, determining whether (N−m₀) is less than M, wherein m₀≥0 and depends on a number of ambisonics channel modes out of the order n of the HOA signal filtered by an all-pass NFC filter. m₀ may be a number of ambisonics channel indices corresponding to the number of ambisonics channel modes filtered by an all-pass NFC filter. If no all-pass NFC filter is used m₀=0. In dependence of the determination whether (N−m₀) is less than M, performing NFC filtering on M unfiltered pre-rendered signals of the set of unfiltered pre-rendered signals or reversing the order of converting and NFC filtering. In particular, if (N−m₀)>M, NFC filtering may be performed on M unfiltered pre-rendered signals of the set of unfiltered pre-rendered signals. Otherwise, the order of converting and NFC filtering may be reversed. Reversing the order may be understood as performing NFC filtering on the set of N ambisonics channel signals to generate a set of N filtered ambisonics channel signals, and converting the set of N filtered ambisonics channel signals into the set of S filtered loudspeaker channel signals. In other words, NFC filtering is performed on the HOA signal, if needed, and conversion is performed on the already filtered HOA signal.

In some embodiments, performing NFC filtering on M unfiltered pre-rendered signals of the set of unfiltered pre-rendered signals may include performing time domain filtering using a digital finite impulse response filter or a digital infinite impulse response filter on each one of the M unfiltered pre-rendered signals individually.

In some embodiments, the method may further include determining a reference distance of the set of N ambisonics channel signals, in particular based on a bitstream of the ambisonics signal. Further, a filter may be determined, in particular coefficients of a filter, for performing the NFC filtering based on the reference distance.

In some embodiments, converting the set of N ambisonics channel signals into the set of M unfiltered pre-rendered signals may be executable using a matrix multiplication of an ambisonics signal matrix C representing a frame of the set of N ambisonics channel signals with a renderer matrix Rₖ, for a given loudspeaker k. The renderer matrix Rₖ for a given loudspeaker k is in particular a (n+1)×N matrix.

According to second aspect, a rendering device for rendering an ambisonics signal using a loudspeaker arrangement comprising S loudspeakers is described; The rendering device is configured to perform the method of the first aspect and any optional embodiments referring to the first aspect.

According to a third aspect, a software program is described. The software program may be adapted for execution on a processor and for performing the method of the first aspect and any optional embodiments referring to the first aspect.

According to fourth aspect, a storage medium is described. The storage medium may comprise a software program adapted for execution on a processor and for performing the method of the first aspect and any optional embodiments referring to the first aspect.

According to a fifth aspect, a computer program product is described. The computer program may comprise executable instructions for performing the method of the first aspect and any optional embodiments referring to the first aspect.

According to sixth aspect, a decoder configured to decode a bitstream indicative of an ambisonics signal which is to be rendered by a loudspeaker arrangement comprising S loudspeaker is described, wherein the decoder comprises a rendering device according to the second aspect.

It should be noted that the methods, devices and systems including its preferred embodiments as outlined in the present patent application may be used stand-alone or in combination with the other methods, devices and systems disclosed in this document.

Furthermore, all aspects of the methods, devices and systems outlined in the present patent application may be arbitrarily combined. In particular, the features of the claims may be combined with one another in an arbitrary manner.

### SHORT DESCRIPTION OF THE FIGURES

The invention is explained below in an exemplary manner with reference to the accompanying drawings, wherein

FIG. 1 shows an example rendering device for rendering an ambisonics audio signal;

FIG. 2a shows an example rendering device with modified NFC processing;

FIG. 2b shows an example rendering device with flexible NFC processing prior to or subsequent to “ambisonics to loudspeaker” conversion;

FIG. 3 shows a flow chart of an example method for rendering an ambisonics audio signal; and

FIG. 4 shows a flow chart of an example method for performing NFC filtering on unfiltered pre-rendered signals.

### DETAILED DESCRIPTION

As outlined above, the present document relates to the efficient rendering of ambisonics, in particular HOA, signals, as used e.g., within the MPEG-H 3D Audio standard. MPEG-H 3D Audio is a coding standard that supports channel-based, object-based and scene-based audio coding, in order to provide enhanced immersive 3D sound experiences.

The MPEG-H 3D Audio Low Complexity Profile decoder supports all formats, including channel-based audio, object-based audio and scene-based audio via higher order ambisonics (HOA). The MPEG-H 3D Audio Low Complexity Profile decoder according to ISO/IEC 23008-3:2019/AMD 2:2020 also support the MPEG-H 3D Audio Baseline Profile, which is a subset of the MPEG-H 3D Audio Low Complexity Profile. The document ISO/IEC 23008-3:2019/AMD 2:2020 is incorporated herein by reference.

As per section 12.4.3.4 NFC Processing (Near Field Compensation Processing) of the specification document ISO/IEC 23008-3:2019(E) (which is incorporated by reference) and as shown in the ambisonics (in particular HOA) renderer 100 of FIG. 1, an NFC filtering block 110 may be used prior to an “HOA to loudspeaker conversion” block 120. In particular, the ambisonics renderer 100 may be configured to receive N ambisonics (notably HOA) channel signals 111 from a decoding block, wherein the decoding block is configured to generate the ambisonics channel signals 111 from an encoded bitstream. In case of headphone rendering, the ambisonics channel signals 111 may be provided to an “ambisonics to headphone conversion (H2B)” block 130, which may be configured to perform binaural rendering of the N ambisonics channel signals 111. In case of loudspeaker rendering, the ambisonics channel signals 111 may be provided to the “ambisonics to loudspeaker conversion” block 120, which is configured to generate S loudspeaker signals 114 for the corresponding S loudspeakers of the loudspeaker arrangement, based on the N ambisonics channel signals 111. The loudspeaker signals 114 may be generated using the ambisonics rendering matrix R 113 (which may be determined based on the arrangement of the S loudspeakers)

The processing within the “HOA to loudspeaker conversion” block 120 may comprise, in particular may consist in, a matrix multiplication:

P=R×C

where R is the HOA renderer matrix 113, where C is the matrix of HOA decoded output channels 111 (also referred to herein as the ambisonics channel signals) and where P is the renderer output 114 (also referred to herein as the loudspeaker channel signals), as shown below:

$$R = [ \begin{matrix}{r}_{0 , 0} & {r}_{0 , 1} & … & {r}_{0 , N - 2} & {r}_{0 , N - 1} \\ {r}_{1 , 0} & {r}_{1 , 1} & … & {r}_{1 , N - 2} & {r}_{1 , N - 1} \\ ⋮ & ⋮ & ⋱ & ⋮ & ⋮ \\ {r}_{S - 2 , 0} & {r}_{S - 2 , 1} & … & {r}_{S - 2 , N - 2} & {r}_{S - 2 , N - 1} \\ {r}_{S - 1 , 0} & {r}_{S - 1 , 1} & … & {r}_{S - 1 , N - 2} & {r}_{S - 1 , N - 1}\end{matrix} ] \\ C = [ \begin{matrix}{c}_{0 , 0} & {c}_{0 , 1} & … & {c}_{0 , L - 1} \\ {c}_{1 , 0} & {c}_{1 , 1} & … & {c}_{1 , L - 1} \\ ⋮ & ⋮ & ⋱ & ⋮ \\ {c}_{N - 1 , 0} & {c}_{N - 1 , 1} & … & {c}_{N - 1 , L - 1}\end{matrix} ] \\ P = [ \begin{matrix}{p}_{0 , 0} & {p}_{0 , 1} & … & {p}_{0 , L - 1} \\ {p}_{1 , 0} & {p}_{1 , 1} & … & {p}_{1 , L - 1} \\ ⋮ & ⋮ & ⋱ & ⋮ \\ {p}_{S - 1 , 0} & {p}_{S - 1 , 1} & … & {p}_{S - 1 , L - 1}\end{matrix} ]$$

The definitions of the variables L, S, N are provided within Table 1

TABLE 1

| | |
|---|---|
| S | Total number of loudspeakers |
| | in the loudspeaker layout |
| n | HOA order |
| N | Number of HOA transport channels, |
| | (n + 1)²for 3D setup, (2n + 1) for 2D setup |
| L | Processing frame length of the |
| | audio data (time domain) |

The elements of the HOA rendering matrix 113, r_{i,j}∀0≤i<S and 0≤j<N, are typically scalar weights for a given speaker layout. Hence, the process of obtaining the final rendered output of a particular channel (i.e., a loudspeaker channel for a particular loudspeaker) can be viewed as a weighted summation of the samples of the HOA channels

$${c}_{j , k} ∀ 0 \leq j < N and 0 \leq k < L i . e ,$$

wherein the element p_{i,k}∀0≤i<S and 0≤k<L of the matrix P can be seen as a weighted sum of c_{j,k}∀0≤j<N where the weights are the rows of the renderer matrix R.

As illustrated in FIG. 1, the ambisonics channel signals 111 may be submitted to NFC processing within the NFC processing block 110 prior to rendering, if it is decided within the decision block 101 that NFC processing is to be applied. The bitstream which is received from a corresponding ambisonics encoder may indicate within a variable or flag “UsesNfc” whether NFC processing is to be applied or not. Alternatively, or in addition, the bitstream may indicate a variable “NfcReferenceDistance” which indicates the reference distance at which sound sources and/or loudspeakers have been assumed to be located during encoding.

The decision block 101 may be configured to decide on whether or not to apply NFC processing based on the variables “UsesNfc” and/or “NfcReferenceDistance”. In particular, NFC processing may be applied only if the variable “UsesNfc” indicates that NFC processing is to be used (e.g., using the value “1”). Furthermore, NFC processing may be applied only if the variable “NfcReferenceDistance” is larger than the value rₘₐₓ, which is the maximum distance at which a loudspeaker of the actual loudspeaker arrangement is located from the position of the listener. The loudspeakers may be arranged e.g., on one or more circles around the position of the listener.

If NFC processing is to be applied, the ambisonics channel signals 111 may be filtered within the NFC processing block 110 to provide filtered channel signals 112. The filtered channel signals 112 may then be processed within the conversion block 120 to provide the (filtered) loudspeaker channel signals 114. The ambisonics channel signals C 111 may then be replaced by the corresponding filtered channel signals 112 within the above-mentioned matrix multiplication.

NFC processing may comprise, in particular may consist in, the application of a digital filter, in particular a finite impulse response (FIR) and/or infinite impulse response (IIR) filter, to the individual ambisonics channel signals 111. The filter coefficients may be determined based on the variable “NfcReferenceDistance”. For a given HOA order n, the filter coefficients may be the same for all ambisonics channels that correspond to an HOA “mode” m within a given HOA order n, where 0≤m≤n. Therefore, for a given HOA order n, a total of (n+1) different NFC filter sets (corresponding to the number of HOA “modes”) are used. The grouping of the ambisonics channels for different HOA orders from 1 to 6 is presented in Table 2.

TABLE 2

| | Number | Ambisonics channel signal groups |
|---|---|---|
| | of NFC | which correspond to increasing |
| | filter | “mode” indices. |
| n | sets | Channel indexing starts from 0. |
| n | n + 1 | Ambisonics channel indices for modes |
| | | (m = 0), (m = 1), . . . (m = n) |
| 1 | 2 | (0), (1, 2, 3) |
| 2 | 3 | (0), (1, 2, 3), (4, 5, 6, 7, 8) |
| 3 | 4 | (0), (1, 2, 3), (4, 5, 6, 7, 8), (9, 10, 11, 12, 13, 14, 15) |
| 4 | 5 | (0), (1, 2, 3), (4, 5, 6, 7, 8), (9, 10, 11, 12, 13, 14, 15), |
| | | (16, 17, 18, 19, 20, 21, 22, 23, 24) |
| 5 | 6 | (0), (1, 2, 3), (4, 5, 6, 7, 8), (9, 10, 11, 12, 13, 14, 15), |
| | | (16, 17, 18, 19, 20, 21, 22, 23, 24), |
| | | (25, 26, 27, 28, 29, 30, 31, 32, 33, 34, 35) |
| 6 | 7 | (0), (1, 2, 3), (4, 5, 6, 7, 8), (9, 10, 11, 12, 13, 14, 15), |
| | | (16, 17, 18, 19, 20, 21, 22, 23, 24), |
| | | (25, 26, 27, 28, 29, 30, 31, 32, 33, 34, 35), |
| | | (36, 37, 38, 39, 40, 41, 42, 43, 44, 45, 46, 47, 48) |

The NFC processing block 110 may be configured to apply the NFC filter within the time domain. Details regarding NFC processing are described in ISO/IEC 23008-3:2019I, notably Section 12.4.3.4, which is incorporated herein by reference.

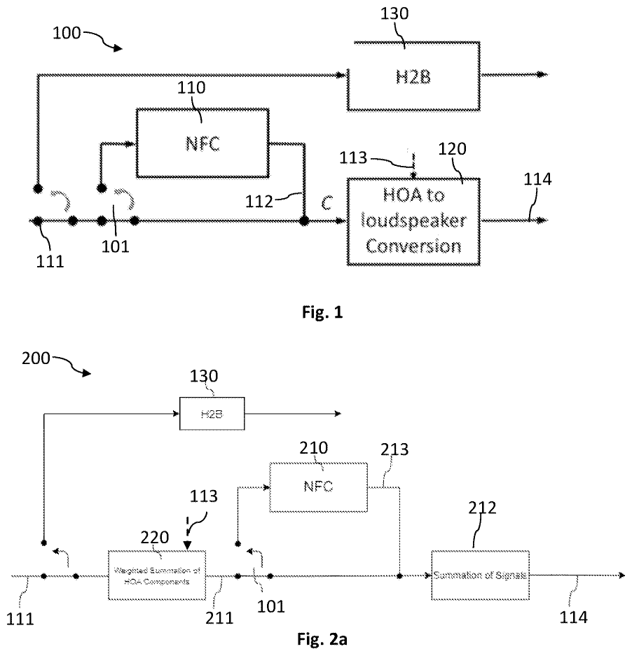

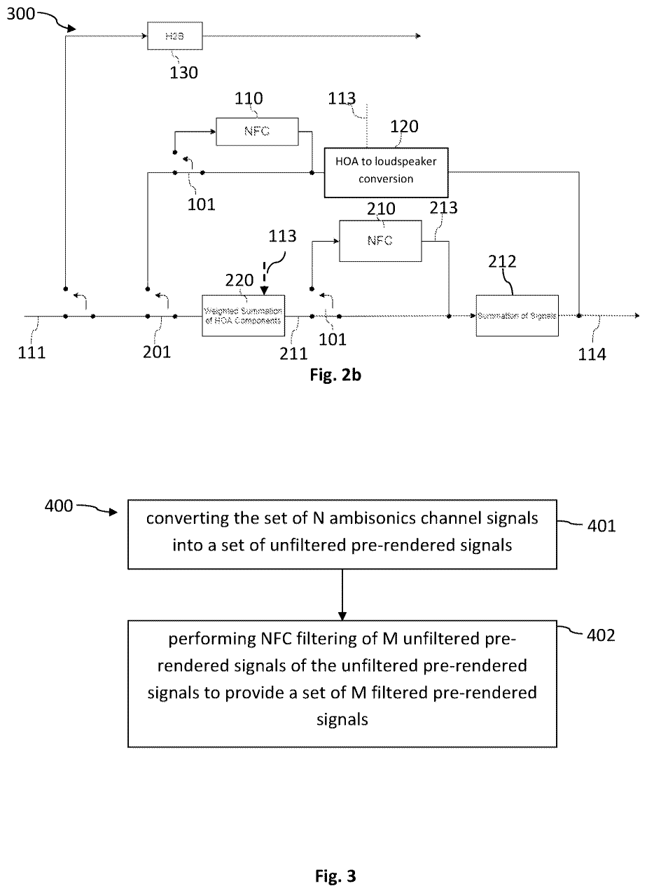

It can be shown that the filtering operation which is performed within the NFC processing block 110 and the matrix multiplication operation which is performed within the conversion block 120 may be rearranged (without impacting the end result). Consequently, an alternative setup 200 of the ambisonics renderer 100 may be provided, as illustrated in FIG. 2a. In the setup 200, the conversion of ambisonics signals to loudspeaker signals is performed in two stages, wherein in the first stage 220 (n+1) sets of S unfiltered pre-rendered loudspeaker signals 211 are obtained from the ambisonics channel signals 111. A parallel processing may be applied to obtain each of the (n+1) sets of unfiltered pre-rendered S loudspeaker signals. For each of the (n+1) sets of unfiltered pre-rendered S loudspeaker signal a conversion is performed by a weighted sum of ambisonics channel signals 111. The weights used for processing each set are taken from a subset of the rendering matrix R 113. For example, for each set m, 0≤m≤n the subset R(m) of the rendering matrix R 113 may be multiplied with the matrix of ambisonics channel signals C 111, i.e.,

$${\underbrace{{P}_{u} ( m )}}_{( S \times 1 )} = {\underbrace{R ( m )}}_{( S \times N )} \cdot {\underbrace{C}}_{( N \times 1 )} ,$$

wherein Pᵤ(m) is the vector of unfiltered pre-rendered loudspeaker signals for one mode m. Note that for simplicity, the size L=1 in the matrix C is justified when performing the processing in the frequency domain where C becomes a vector of a particular frequency bin.

For example, the weights for the first set (m=0) of S pre-rendered loudspeaker signals 211 correspond to the first column of the rendering matrix R 113 and the weights for the second set (m=1) of S unfiltered pre-rendered loudspeaker signals 211 correspond to a matrix of the second, third and fourth columns of the rendering matrix R 113. Note that this assignment is derived from the grouping as illustrated in Table 2 where for the first set only one ambisonics channel is involved, i.e., the first channel (0), hence the first column of rendering matrix R 113; whereas for the second set a group of 3 subsequent ambisonics channels are involved, i.e., channels (1, 2, 3), hence the next three columns of rendering matrix R 113.

In the second stage, NFC filtering 210 is applied to the set or a subset of pre-rendered loudspeaker signals 211. In particular, for each of the (n+1) sets of unfiltered pre-rendered S loudspeaker signals 211 or a subset thereof, NFC filtering is applied individually to provide (n+1) sets of filtered pre-rendered S loudspeaker signals 213 or a subset thereof. For example, one of the (n+1) sets of filtered pre-rendered S loudspeaker signals 213 is calculated as

$${\underbrace{{P}_{f} ( m )}}_{( S \times 1 )} = {\underbrace{d ( m )}}_{( 1 \times 1 )} \cdot {\underbrace{{P}_{u} ( m )}}_{( S \times 1 )} ,$$

wherein d(m) is an NFC filter coefficient and P_{f}(m) is the vector of filtered pre-rendered loudspeaker signals for mode m. Note that for simplicity the multiplication operation is assuming a frequency domain processing, the corresponding convolution operation is performed in time domain.

The resulting (n+1) sets of filtered pre-rendered S loudspeaker signals 213 are summed up in block 212 to get the corresponding loudspeaker channel signals 114. If only a subset of the (n+1) sets is filtered, the subset and the remaining unfiltered signals are summed up, i.e., a total of (n+1) signals for each loudspeaker S. For example, loudspeaker channel signals 114 are calculated as

$${\underbrace{P}}_{( S \times 1 )} = {\sum }_{m = 0}^{n} {\underbrace{{P}_{f} ( m )}}_{( S \times 1 )} ,$$

wherein P is the vector of loudspeaker channel signals 114.

In other words, in block 212, for each loudspeaker, (n+1) signals, which correspond to the same particular loudspeaker, are summed up, yielding a total of S filtered and rendered loudspeaker signals 114. Notably, the loudspeaker channel signals 114 in FIG. 2a are identical to the loudspeaker channel signals 114 in FIG. 1.

In case the NFC processing is not required in this setup, a direct conversion to the loudspeaker channel signals 114 can also be done by processing the ambisonics channel signals 111 with the rendering matrix R 113.

In the setup of FIG. 1, NFC processing is applied to N ambisonics channel signals 111, whereas in the setup of FIG. 2a, NFC processing is applied to S*(n+1) signals. Hence, the setup of FIG. 2a is computationally more efficient than the setup of FIG. 1, if the following holds: S*(n+1)<N or S<(n+1) for the 3D setup. Note that this document mainly describes the 3D setup, but it can easily be extended to the 2D setup.

Consequently, in case of an “all-pass” NFC filter is applied on one of the modes, as commonly done for m=0 for example, the condition above should be adjusted, e.g., S*n<N−1. More generally, the condition can be expressed as S*(n+1−m₁)<N−m, wherein m₁ is a number of ambisonics channel modes, out of the order n of the HOA signal, filtered by an all-pass NFC filter, and m₀ is a number of ambisonics channel indices corresponding to the number of ambisonics channel modes m₁.

Table 3 illustrates the reduction in filtering operations which may be achieved for different scenarios.

TABLE 3

| | Number of Channels that | | |
|---|---|---|---|
| | undergo NFC filtering | | |
| | Setup of | Setup of | % Reduction in |
| (n, S) | FIG. 1 | FIG. 2a | operations |
| (2, 4) | 9 | 12 | −33.33 |
| (2, 2) | 9 | 6 | 33.33 |
| (3, 2) | 16 | 8 | 50.00 |
| (4, 3) | 25 | 15 | 20.00 |
| (5, 5) | 36 | 30 | 16.66 |
| (6, 6) | 49 | 42 | 14.28 |
| (7, 6) | 64 | 48 | 25.00 |
| (8, 6) | 81 | 54 | 33.33 |
| (9, 6) | 100 | 60 | 40.00 |
| (10, 6) | 121 | 66 | 45.45 |

Hence, the setup of FIG. 2a is efficient at relatively high ambisonics orders n, for the relatively common speaker layout with S=6 speakers supported by the MPEG-H LC decoder. In general, the setup of FIG. 2a is more efficient, when the number N of HOA channels is higher than the number S*(n+1) of speakers in the target loudspeaker layout.

FIG. 2b illustrates an ambisonics renderer 300 which makes use of a decision unit 201 which is configured to change the order of conversion processing and NFC processing, in dependence of the number N of ambisonics channels and the number S of loudspeaker channels. In case of S≥(n+1), NFC processing (in block 110) may be performed prior to conversion processing (in block 120). On the other hand, in case of S<(n+1), NFC processing (in block 210) may be performed subsequent to conversion processing (in block 220). As a result of this, a particularly efficient processing may be achieved as illustrated in Table 4.

TABLE 4

| | Number of Channels that | | |
|---|---|---|---|
| | undergo NFC filtering | | |
| | Setup of | Setup of | % Reduction |
| (n, S) | FIG. 1 | FIG. 2b | in operations |
| (2, 4) | 9 | 9 | 0.00 |
| (2, 2) | 9 | 6 | 33.33 |
| (3, 2) | 16 | 8 | 50.00 |
| (4, 3) | 25 | 15 | 20.00 |
| (5, 5) | 36 | 30 | 16.66 |
| (6, 6) | 49 | 42 | 14.28 |
| (7, 6) | 64 | 48 | 25.00 |
| (8, 6) | 81 | 54 | 33.33 |
| (9, 6) | 100 | 60 | 40.00 |
| (10, 6) | 121 | 66 | 45.45 |

FIG. 3 shows a flow chart of an example (computer-implemented) method 400 for rendering an ambisonics audio signal using a loudspeaker arrangement comprising S loudspeakers. The ambisonics audio signal may be provided within a bitstream. The method 400 may be executed by a decoder which is configured to decode the bitstream. In particular, a set of N ambisonics channel signals 111 may be derived from the bitstream. The set of N ambisonics channel signals 111 may be a higher order ambisonics (HOA) signal. The number N of ambisonics channel signals 111 may be N=(n+1)², with n being the order of the ambisonics signal, e.g., with n>1.

The method 400 may comprise converting 401 the set of N ambisonics channel signals 111 into a set of unfiltered pre-rendered signals 211. For example, the size of the set of unfiltered pre-rendered signals 211 is equal to S*(n+1). Typically, N>1 and typically S>1. In particular S>2, e.g., S=6 or S=16. Hence, loudspeaker channels signals 114 may be derived from the HOA signal.

Converting the set of N ambisonics channel signals 111 into the set of unfiltered pre-rendered signals 211 may be executable and/or may be performed using a matrix multiplication of an ambisonics signal matrix C (which represents a frame of the set of N ambisonics channel signals 111) with a renderer matrix R(m), where 0≤m≤n, for each of the “mode” m given the ambisonics order n. The renderer matrix R(m), for each “mode” m may be an S×N matrix filled with zeroes but with non-zero elements of a subset of column vectors of the renderer matrix R. The indices of the column vectors are taken from Table 2. For example, for n=2, the non-zero elements of the renderer matrix R(m), for m=2 are the (5^{th}, 6^{th}, 7^{th}, 8^{th}, 9^{th}) column vectors of the renderer matrix R which correspond to the ambisonics channel indices in the group (4, 5, 6, 7, 8) of Table 2. Note that the column vector indices are merely an offset (+1) of the ambisonics channel indices and they are placed at the same positions in R(m), as in R. In the actual implementation, it is not necessary to construct such a redundant matrix, the element-wise multiplications are sufficient to perform this operation.

Hence, the conversion from the HOA signal into the different loudspeaker channel signals may be performed by calculating linear combinations of the different ambisonics channel signals using different sets of weights (from the renderer matrix R).

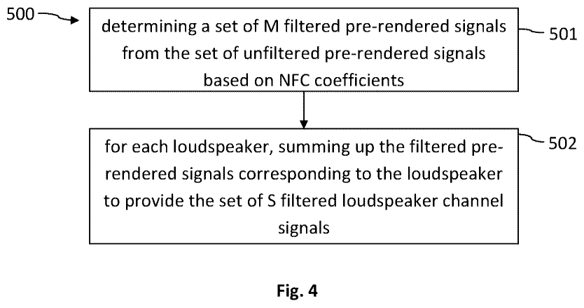

Furthermore, the method 400 comprises performing 402 near field compensation (NFC) filtering of M unfiltered pre-rendered signals 211 of the set of unfiltered pre-rendered signals 211 to provide a set of M filtered pre-rendered signals 213. For example, M is equal to S*(n+1). An example of step 402 is shown in FIG. 4.

FIG. 4 shows a flow chart of an example (computer-implemented) method 500 for NFC filtering of the set of M unfiltered pre-rendered signals.

In step 501, a set of M filtered pre-rendered signals 213 is determined from the set of unfiltered pre-rendered signals 211 based on NFC coefficients. In particular, the unfiltered pre-rendered signals 211 of the set of unfiltered pre-rendered signals 211 may be multiplied by corresponding NFC filter coefficients to provide the set of M filtered pre-rendered signals 213.

In step 502, for each loudspeaker, the filtered pre-rendered signals 213 corresponding to the loudspeaker are summed up to provide the set of S filtered loudspeaker channel signals 114. The set of S filtered loudspeaker channel signals 114 may be rendered to the corresponding loudspeakers.

Method 400 may comprise providing the S filtered loudspeaker channel signals 114 to the corresponding S loudspeakers, respectively. Alternatively, or in addition, the method 400 may comprise rendering the S filtered loudspeaker channel signals 114 using the corresponding S loudspeakers, respectively.

Performing NFC filtering on the set of unfiltered pre-rendered signals 211 may comprise performing time domain filtering using a digital finite impulse response (FIR) filter and/or a digital infinite impulse (IIR) response filter on each one of the M unfiltered pre-rendered signals 211 individually. The filter for NFC processing may be determined based on data which is provided within the bitstream regarding the ambisonics audio signal. In particular, the method 400 may comprise determining a reference distance of the set of N ambisonics channel signals 111, in particular based on the bitstream of the ambisonics signal. Furthermore, the method 400 may comprise determining the filter, in particular coefficients of the filter, for performing NFC processing based on the reference distance.

NFC processing may be used to compensate for the fact that loudspeakers which are positioned at a limited distance from the listener position do not emit ideal planar sound waves, wherein the soundfield representation used for ambisonics typically assumes the emitted sound waves to be planar waves.

Hence, a method 400 is described, which applies NFC processing on the loudspeaker channel signals (in contrast to applying NFC processing on the ambisonics channel signals). This may lead to substantial reductions in computational complexity, without impacting the perceptual quality.

The method may further comprise determining whether or not the number S of loudspeakers is less than (and equal to) the number (n+1), n being the HOA order. M may be S*(n+1). NFC filtering may be performed on the set of S*(n+1) unfiltered pre-rendered signals 211 if, in particular only if, (n+1)>S or (n+1)≥S. As a result of this, the computational complexity may be reduced.

Hence, the method may comprise determining whether or not the number S of loudspeakers is less than the number (n+1), n being the HOA order. In dependence thereof, NFC filtering may be performed (either) on the set of S*(n+1) unfiltered pre-rendered signals 211 or on the set of N ambisonics channel signals 111. In particular, NFC filtering may be performed on the set of S*(n+1) unfiltered pre-rendered signals 211, if (n+1)>S. On the other hand, NFC filtering may be performed on the set of N ambisonics channel signals 111, if (n+1)<S. In particular, if (n+1)<S, method 400 may comprise NFC filtering on the set of N ambisonics channel signals 111 to generate a set of N filtered ambisonics channel signals 112 and converting the set of N filtered ambisonics channel signals 112 into the set of S filtered loudspeaker channel signals 114. Hence, in case of (n+1)<S NFC filtering may be performed selectively prior to “ambisonics to loudspeaker” conversion. As a result of this, the computational complexity may be reduced in a particularly extensive manner.

Consequently, the method 400 may flexibly perform NFC filtering prior or subsequent to “ambisonics to loudspeaker” conversion. By doing this, the computational complexity may be reduced.

In the present document, a method and a rendering device have been described which allow ambisonics, in particular HOA, signals to be rendered by a loudspeaker layout in a particularly efficient manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

Various aspects of the present invention may be appreciated from the following enumerated example embodiments (EEEs):
EEE1) A method (400) for rendering an ambisonics signal using a loudspeaker arrangement comprising S loudspeakers; wherein the method (400) comprises,
   converting (401) a set of N ambisonics channel signals (111) into a set of unfiltered pre-rendered signals (211); wherein N>1 and S>1; and
   performing (402) near field compensation, referred to as NFC, filtering of M unfiltered pre-rendered signals (211) of the set of unfiltered pre-rendered signals (211) to provide a set of S filtered loudspeaker channel signals (114) for rendering using the corresponding S loudspeakers.
EEE2) The method (400) of EEE 2, wherein performing (402) NFC filtering of M unfiltered pre-rendered signals (211) of the set of unfiltered pre-rendered signals (211) to provide a set of S filtered loudspeaker channel signals (114) for rendering using the corresponding S loudspeakers comprises,
   determining a set of M filtered pre-rendered signals from the set of M unfiltered pre-rendered signals based on NFC coefficients; and
   summing the filtered pre-rendered signals and remaining unfiltered pre-rendered signals, corresponding to a loudspeaker, for each loudspeaker S to provide the set of S filtered loudspeaker channel signals (114).
EEE3) The method (400) of any previous EEE, wherein M depends on the number of loudspeakers S and an order n of a higher order ambisonics (HOA) signal corresponding to the set of N ambisonics channel signals (111).
EEE4) The method (400) of any previous EEE, wherein M=S*(n+1−m₁), and m₁ is a number of Ambisonics channel modes out of the order n of the HOA signal filtered by an all-pass NFC filter.
EEE5) The method (400) of EEEs 4, when depending on EEE 2, wherein the filtered pre-rendered signals and remaining unfiltered pre-rendered signals, corresponding to a loudspeaker are a number n+1−m₁ and m₁ signals, respectively.
EEE6) The method (400) of any one of EEEs 4 to 5, wherein m₁=0.
EEE7) The method (400) of any one of EEEs 3 to 6, when depending on EEE 2, wherein determining a set of M filtered pre-rendered signals from the set of unfiltered pre-rendered signals based on NFC coefficients comprises,
   multiplication in the frequency in domain of each of the S unfiltered pre-rendered signals of the M unfiltered pre-rendered signals (211) of the set of unfiltered pre-rendered signals with an NFC coefficient d(m), for each m, 0≤m≤n;
   or convolution in time domain of each of the S unfiltered pre-rendered signals of M unfiltered pre-rendered signals (211) of the set of unfiltered pre-rendered signals with an NFC filter dₘ, for each m, 0≤m≤n.
EEE8) The method (400) of any one of EEEs 3 to 7, wherein the method (400) comprises,
   determining whether (N−m₀) is less than M, wherein m₀≥0 and depends on a number of Ambisonics channel modes out of the order n of the HOA signal filtered by an all-pass NFC filter; and
wherein performing (402) near field compensation, referred to as NFC filtering M unfiltered pre-rendered signals (211) of the set of unfiltered pre-rendered signals (211) to provide a set of S filtered loudspeaker channel signals (114) for rendering using the corresponding S loudspeakers comprises,
   performing (402) NFC filtering on M unfiltered pre-rendered signals (211) of the set of unfiltered pre-rendered signals (211) if, in particular only if, (N−m₀)>M or (N−m₀)≥M.
EEE9) The method (400) of any one of EEEs 3 to 8, wherein before converting (401) a set of N ambisonics channel signals (111) into a set of unfiltered pre-rendered signals (211), the method (400) further comprises,
   determining whether (N−m₀) is less than M, wherein m₀≥0 and depends on a number of Ambisonics channel modes out of the order n of the HOA signal filtered by an all-pass NFC filter; and
   in dependence thereof, performing (402) NFC filtering on M unfiltered pre-rendered signals (211) of the set of unfiltered pre-rendered signals (211) or reversing the order of converting and NFC filtering.
EEE10) The method (400) of EEE 9, wherein
   performing (402) NFC filtering on M unfiltered pre-rendered signals (211) of the set of unfiltered pre-rendered signals (211), if (N−m₀)>M; and
   reversing the order of converting and NFC filtering, if (N−m₀)<M.
EEE11) The method (400) of any one of EEEs 9 to 10, wherein reversing the order of converting and NFC filtering comprises,
   performing NFC filtering on the set of N ambisonics channel signals (111) to generate a set of N filtered ambisonics channel signals (112); and
   converting the set of N filtered ambisonics channel signals (112) into the set of S filtered loudspeaker channel signals (114).
EEE12) The method (400) of any one of EEEs 8 to 12, wherein m₀ is a number of Ambisonics channel indices corresponding to the number of Ambisonics channel modes filtered by an all-pass NFC filter.
EEE13) The method (400) of EEE 12, wherein m₀=0.
EEE14) The method (400) of any previous EEE, wherein performing (402) NFC filtering on M unfiltered pre-rendered signals (211) of the set of unfiltered pre-rendered signals (211) comprises performing time domain filtering using a digital finite impulse response filter or a digital infinite impulse response filter on each one of the M unfiltered pre-rendered signals (211) individually.
EEE15) The method (400) of any previous EEEs, wherein the method comprises,
   determining a reference distance of the set of N ambisonics channel signals (111), in particular based on a bitstream of the ambisonics signal; and
   determining a filter, in particular coefficients of a filter, for performing the NFC filtering based on the reference distance.
EEE16) The method (400) of any previous EEEs, wherein
   the set of N ambisonics channel signals (111) is a higher order ambisonics (HOA) signal; and/or
   N=(n+1)², with n being an order of the HOA signal, with n>1.
EEE17) The method (400) of any previous EEEs, wherein
   S>2; and/or
   S=6; or
   S=16.
EEE18) The method (400) of any previous EEEs, wherein
   converting (401) the set of N ambisonics channel signals (111) into the set of M unfiltered pre-rendered signals (211) is executable using a matrix multiplication of an ambisonics signal matrix C representing a frame of the set of N ambisonics channel signals (111) with a renderer matrix Rₖ, for a given loudspeaker k
   the renderer matrix Rₖ for a given loudspeaker k is in particular a (n+1)×N matrix.
EEE19) A computer program product comprising instructions which, when being executed by a computer, cause the computer to carry out the method (400) according any of the previous EEEs.
EEE20) A rendering device (100) for rendering an ambisonics signal using a loudspeaker arrangement comprising S loudspeakers; wherein the rendering device (100) is configured to,
   convert (401) a set of N ambisonics channel signals (111) into a set of unfiltered pre-rendered signals (211); wherein N>1 and S>1; and
   perform (402) near field compensation, referred to as NFC, filtering of M unfiltered pre-rendered signals (211) of the set of unfiltered pre-rendered signals (211) to provide a set of S filtered loudspeaker channel signals (114) for rendering using the corresponding S loudspeakers.
EEE21) A method (400) for rendering an ambisonics signal using a loudspeaker arrangement comprising S loudspeakers; wherein the method (400) comprises,
   converting (401) a set of N ambisonics channel signals (111) into a set of S unfiltered loudspeaker channel signals (214); wherein N>1 and S>1; and
   performing (402) near field compensation, referred to as NFC, filtering of the set of S unfiltered loudspeaker channel signals (214) to provide a set of S filtered loudspeaker channel signals (114) for rendering using the corresponding S loudspeakers.
EEE22) The method (400) of EEE 21, wherein the method (400) comprises,
   determining whether or not the number N of ambisonics channel signals (111) is greater than the number S of loudspeakers; and
   performing (402) NFC filtering on the set of S unfiltered loudspeaker channel signals (214) if, in particular only if, N>S or N≥S.
EEE23) The method (400) of any one of the EEEs 21 to 22, wherein the method (400) comprises,
   determining whether or not the number N of ambisonics channel signals (111) is greater than the number S of loudspeakers; and
   in dependence thereof, performing (402) NFC filtering on the set of S unfiltered loudspeaker channel signals (214) or performing NFC filtering on the set of N ambisonics channel signals (111).
EEE24) The method (400) of EEE 23, wherein the method (400) comprises,
   performing (402) NFC filtering on the set of S unfiltered loudspeaker channel signals (214), if N>S; and
   performing NFC filtering on the set of N ambisonics channel signals (111), if N<S.
EEE25) The method (400) of any of EEEs 23 to 25, wherein the method (400) comprises, if N<S,
   performing NFC filtering on the set of N ambisonics channel signals (111) to generated a set of N filtered ambisonics channel signals (112); and
   converting the set of N filtered ambisonics channel signals (112) into the set of S filtered loudspeaker channel signals (114).
EEE26) The method (400) of any one of the EEEs 21 to 25, wherein performing NFC filtering on the set of S unfiltered loudspeaker channel signals (214) comprises performing time domain filtering using a digital finite impulse response filter or a digital infinite impulse response filter on each one of the S unfiltered loudspeaker channel signals (214) individually.
EEE27) The method (400) of any one of the EEEs 21 to 26, wherein the method comprises
   determining a reference distance of the set of N ambisonics channel signals (111), in particular based on a bitstream of the ambisonics signal; and
   determining a filter, in particular coefficients of a filter, for performing NFC processing based on the reference distance.
EEE28) The method (400) of any one of the EEEs 21 to 27, wherein
   the set of N ambisonics channel signals (111) is a higher order ambisonics signal; and/or
   N=(n+1)², with n being an order of the ambisonics signal, with n>1.
EEE29) The method (400) of any one of the EEEs 21 to 28, wherein
   S>2; and/or
   S=6; or
   S=16.
EEE30) The method (400) of any one of the EEEs 21 to 29, wherein
   converting (401) the set of N ambisonics channel signals (111) into the set of S unfiltered loudspeaker channel signals (214) is executable using a matrix multiplication of an ambisonics signal matrix C representing a frame of the set of N ambisonics channel signals (111) with a renderer matrix R, to provide a loudspeaker signal matrix P representing a frame of the set of S unfiltered loudspeaker channel signals (214); and
   the renderer matrix R is in particular a S×N matrix.
EEE31) The method (400) of any one of the EEEs 21 to 30, wherein the method (400) comprises
   proving the S filtered loudspeaker channel signals (114) to the corresponding S loudspeakers, respectively; and/or
   rendering the S filtered loudspeaker channel signals (114) using the corresponding S loudspeakers, respectively.
EEE32) A method (500) for rendering an ambisonics signal using a loudspeaker arrangement comprising S loudspeakers; wherein the method (500) comprises,
   performing (501) joint synthesis and rendering on a set of ambisonics ambience signals (301), to determine a set of S ambience loudspeaker signals;
   performing (502) joint synthesis and rendering on a set of predominant sound signals (302), to determine a set of S predominant loudspeaker signals; and
   combining (503) the set of S ambience loudspeaker signals and the set of S predominant loudspeaker signals to provide a set of S unfiltered loudspeaker channel signals (214); wherein S>1; and
   performing (504) near field compensation, referred to as NFC, filtering of the set of S unfiltered loudspeaker channel signals (214) to provide a set of S filtered loudspeaker channel signals (114) for rendering using the corresponding S loudspeakers.
EEE33) A computer program product comprising instructions which, when being executed by a computer, cause the computer to carry out the method (300, 400) according of any one of the EEEs 21 to 32.
EEE34) A rendering device (100) for rendering an ambisonics signal using a loudspeaker arrangement comprising S loudspeakers; wherein the rendering device (100) is configured to,
   convert a set of N ambisonics channel signals (111) into a set of S unfiltered loudspeaker channel signals (214); wherein N>1 and S>1; and
   perform near field compensation, referred to as NFC, filtering of the set of S unfiltered loudspeaker channel signals (214) to provide a set of S filtered loudspeaker channel signals (114) for rendering using the corresponding S loudspeakers.
EEE35) A rending device for rendering an ambisonics signal using a loudspeaker arrangement comprising S loudspeakers; wherein the rendering device is configured to,
   perform joint synthesis and rendering on a set of ambisonics ambience signals (301), to determine a set of S ambience loudspeaker signals;
   perform joint synthesis and rendering on a set of predominant sound signals (302), to determine a set of S predominant loudspeaker signals; and
   combine the set of S ambience loudspeaker signals and the set of S predominant loudspeaker signals to provide a set of S unfiltered loudspeaker channel signals (214); wherein S>1; and
   perform near field compensation, referred to as NFC, filtering of the set of S unfiltered loudspeaker channel signals (214) to provide a set of S filtered loudspeaker channel signals (114) for rendering using the corresponding S loudspeakers.
EEE36) A decoder (300) configured to decode a bitstream indicative of an ambisonics signal which is to be rendered by a loudspeaker arrangement comprising S loudspeaker; wherein the decoder (300) comprises a rendering device (100) according to any of EEEs 34 to 35.

1. A method for rendering an ambisonics signal using a loudspeaker arrangement comprising S loudspeakers, wherein the method comprises:
converting a set of N ambisonics channel signals into a set of unfiltered pre-rendered signals, wherein N>1 and S>1; and
performing near field compensation, referred to as NFC, filtering of M unfiltered pre-rendered signals of the set of unfiltered pre-rendered signals to provide a set of S filtered loudspeaker channel signals for rendering using the corresponding S loudspeakers.

2. The method of claim 1, wherein performing NFC filtering of M unfiltered pre-rendered signals of the set of unfiltered pre-rendered signals to provide a set of S filtered loudspeaker channel signals for rendering using the corresponding S loudspeakers comprises:
determining a set of M filtered pre-rendered signals from the set of M unfiltered pre-rendered signals based on NFC coefficients; and
summing the filtered pre-rendered signals and remaining unfiltered pre-rendered signals, corresponding to a loudspeaker, for each loudspeaker S to provide the set of S filtered loudspeaker channel signals.

3. The method of claim 2, wherein M depends on the number of loudspeakers S and an order n of a higher order ambisonics (HOA) signal corresponding to the set of N ambisonics channel signals.

4. The method of claim 1, wherein
M=S*(n+1−m₁), and m₁ is a number of Ambisonics channel modes out of the order n of the HOA signal filtered by an all-pass NFC filter.

5. The method of claim 4, wherein the filtered pre-rendered signals and remaining unfiltered pre-rendered signals, corresponding to a loudspeaker, are a number of n+1−m₁ and m₁ signals, respectively.

6. The method of claim 5, wherein m₁=0.

7. The method of claim 3, wherein determining a set of M filtered pre-rendered signals from the set of M unfiltered pre-rendered signals based on NFC coefficients comprises either:
multiplication in the frequency in domain of each of the S unfiltered pre-rendered signals of M unfiltered pre-rendered signals of the set of unfiltered pre-rendered signals with an NFC coefficient d(m), for each m, 0≤m≤n;
or convolution in time domain of each of the S unfiltered pre-rendered signals of M unfiltered pre-rendered signals of the set of unfiltered pre-rendered signals with an NFC filter dₘ, for each m, 0≤m≤n.

8. The method of claim 3, further comprising:
determining whether (N−m₀) is less than M, wherein m₀≥0 and depends on a number of Ambisonics channel modes out of the order n of the HOA signal filtered by an all-pass NFC filter; and
wherein performing NFC filtering comprises performing NFC filtering on M unfiltered pre-rendered signals of the set of unfiltered pre-rendered signals if (N−m₀)>M or (N−m₀)≥M.

9. The method of claim 3, wherein before converting a set of N ambisonics channel signals into a set of unfiltered pre-rendered signals, the method further comprises:
determining whether (N−m₀) is less than M, wherein m₀≥0 and depends on a number of Ambisonics channel modes out of the order n of the HOA signal filtered by an all-pass NFC filter; and
either performing NFC filtering on M unfiltered pre-rendered signals of the set of unfiltered pre-rendered signals or reversing the order of converting and NFC filtering.

10. The method of claim 9, wherein
performing NFC filtering on M unfiltered pre-rendered signals of the set of unfiltered pre-rendered signals, if (N−m₀)>M; and
reversing the order of converting and NFC filtering, if (N−m₀)<M.

11. The method of claim 9, wherein reversing the order of converting and NFC filtering comprises,
performing NFC filtering on the set of N ambisonics channel signals to generate a set of N filtered ambisonics channel signals; and
converting the set of N filtered ambisonics channel signals into the set of S filtered loudspeaker channel signals.

12. The method of claim 8, wherein m₀ is a number of Ambisonics channel indices corresponding to the number of Ambisonics channel modes filtered by an all-pass NFC filter.

13. The method of claim 12, wherein m₀=0.

14. The method of claim 1, wherein performing NFC filtering on M unfiltered pre-rendered signals of the set of unfiltered pre-rendered signals comprises performing time domain filtering using a digital finite impulse response filter or a digital infinite impulse response filter on each one of the M unfiltered pre-rendered signals individually.

15. The method of claim 1, further comprising:
determining a reference distance of the set of N ambisonics channel signals; and
determining a filter for performing the NFC filtering based on the reference distance.

16. The method of claim 12, wherein
the set of N ambisonics channel signals is a higher order ambisonics (HOA) signal; and
N=(n+1)², with n being an order of the HOA signal, with n>1.

17. The method of claim 12, wherein
S>2, and
S=6 or S=16.

18. The method of claim 12, wherein
converting the set of N ambisonics channel signals into the set of M unfiltered pre-rendered signals is executable using a matrix multiplication of an ambisonics signal matrix C representing a frame of the set of N ambisonics channel signals with a renderer matrix Rₖ, for a given loudspeaker k, and
the renderer matrix Rₖ for a given loudspeaker k is in particular a (n+1)×N matrix.

19. A non-transitory computer program product comprising instructions which, when being executed by a computer, cause the computer to carry out the method according of claim 1.

20. A rendering device for rendering an ambisonics signal using a loudspeaker arrangement comprising S loudspeakers; the device comprising:
a converter for converting a set of N ambisonics channel signals into a set of unfiltered pre-rendered signals (211); wherein N>1 and S>1; and
a processor for performing near field compensation, referred to as NFC, filtering of M unfiltered pre-rendered signals of the set of unfiltered pre-rendered signals to provide a set of S filtered loudspeaker channel signals for rendering using the corresponding S loudspeakers.
